(19) United States
(12) Patent Application Publication
(10) Pub. No.: US 2009/0250159 A1
(43) Pub. Date: Oct. 8, 2009

(54) Carrierless Laminate

(76) Inventor: Kaoru Tanigawa, Princeton, NJ (US)

Correspondence Address: Cozen O''Connor, 250 PARK AVENUE, NEW YORK, NY, 10177, US

(21) Appl. No.: 12/420,199

(22) Filed: Apr. 8, 2009

Related U.S. Application Data
(60) Provisional application No. 61/043,210, filed on Apr. 8, 2008.

(51) Int. Cl. B32B 38/10

(52) U.S. Cl. 156/248; 156/517

(57) ABSTRACT

A lamination system comprises a lamina supply to supply a first web comprising lamina sheets or patches, a substrate supply to supply a second web having defined substrates to be laminated, and a separation station where lamina sheets or patches from the first web are laminated to the defined substrates. The substrate is preferably a card, such as an identification card, a credit card, or other CR80 size card. The sheets or patches are approximately the same size as the substrates, and the sheets or patches are subjected to heat and/or pressure to cause them to bond to the substrates.

### FIELD OF THE INVENTION

This present invention relates generally to a process and system for laminating data bearing identification and financial documents. More particularly, the invention relates to a process and system for laminating data-bearing identification and financial documents comprising application of a single polymeric layer as a topcoat to the documents.

### BACKGROUND OF THE INVENTION

The use of laminated cards such as credit cards, debit cards, driver's licenses, national identification cards, and other similar cards, as well as passports and the like, is well known. Such cards are often adorned with text and images using resin and dye diffusion thermal transfer ribbons. The cards may also be provided with one or more printed characters and/or images, holographic images, embossed characters, laser-produced information, and data storage media such as an integrated circuit chip. Unless the cards are protected with another resin layer or film laminate, the dye (and thus the images printed on the card) can rapidly degrade from abrasion, chemical attack from plasticizers, such as those found in vinyl wallet windows, and from extended exposure to sunlight.

To protect the documents and the information provided thereon, it is common to provide a topcoat, comprising a plastic lamina, to the surfaces of the documents. Typically, the front surface of the document is covered by a topcoat and the rear surface is uncovered. In some cases, the rear surface can also be covered by a second topcoat such that both the front and rear surfaces are covered by topcoats.

Thermal transfer resin layers typically used in the plastic card industry consist of thin acrylic coatings. These provide some protection to the card surfaces and to the printed information, but have not proven to be durable. Another problem is that dye migration may still occur since the thermal film is made of porous material which cannot protect the dye from plasticizers and the like. The thin acrylic coatings also tend to peel and flake from cards when laminated causing debris problems in the printer.

Thicker laminates have been used consisting of polyester film (PET) coated with a thermal transfer adhesive. These laminates are typically carried on a substrate or carrier layer. After the lamina layer is contacted with the surface of, e.g., a document, the substrate layer and remaining lamina material are carried off, for disposal or recycling. This process results in unnecessary costs due to the disposal of unused materials or the expense of recycling.

### OBJECTS OF THE INVENTION

It is an object of the present invention to develop an improved process or system for laminating cards or documents.

It is another object of the present invention to provide a process and system for laminating cards or documents wherein a single layer lamina is contacted with a card or document.

Yet another object of the present invention is to provide a process and system wherein a single layer lamina is contacted with a card or document, a portion of lamina corresponding to the card or document is applied to the card or document, and remaining lamina is removed.

It is a further object of the invention to provide a lamination system comprising:

a lamina supply to supply a first web comprising lamina sheets or patches,

a substrate supply to supply a second web having defined substrates to be laminated, and

a separation station where lamina sheets or patches from the first web are laminated to the defined substrates.

It is a further object of the invention to provide a method of lamination an object, comprising:

supplying a first web comprising lamina sheets or patches,

supplying a second web having defined substrates to be laminated,

separating the lamina sheets or patches from the first web, and

laminating the lamina sheets or patches to the defined substrates.

These and other objects of the invention will become more apparent in the discussion below.

### SUMMARY OF THE INVENTION

According to the invention, a substrate such as a card or document is laminated by use of a single layer lamina. More particularly, lamina material is provided, preferably in a roll or spool, wherein the lamina has been treated, e.g., scored or perforated, to form defined areas corresponding to the substrates to be laminated. The treated lamina is positioned adjacent to a substrate, whereupon pressure and/or heat is applied to cause the defined area to bond to the substrate. The remaining portion of the lamina material is removed, and processing of the laminated substrate continues. In some instances the recovered lamina material may be recycled and reused.

In one embodiment of the invention, a lamina to be laminated onto a substrate is separated from a web containing a plurality of lamina. As a result, the rollers of the lamination station can be used to transport the lamina, thereby avoiding the need for a separate transport mechanism for transporting the lamina to the lamination station.

In one embodiment of the invention, a lamination system comprises:

a lamina supply to supply a first web comprising lamina sheets or patches,

a substrate supply to supply a second web having defined substrates to be laminated, and

a separation station where lamina sheets or patches from the first web are laminated to the defined substrates.

Preferably the lamina supply comprises a spool of a web having defined patches. The patches can be defined by any mechanical, electrical, or chemical device or process that would define the patches but leave the patches removably attached or integrated with the web, so that they can be removed at the separation station. The patches can be defined by, for example, perforations, laser cuts, or any other suitable device or process.

In another embodiment of the invention, a laminated card or other substrate is prepared by the method comprising:

supplying a first web comprising lamina sheets or patches,

supplying a second web having defined substrates to be laminated,

separating the lamina sheets or patches from the first web, and

laminating the lamina sheets or patches to the defined substrates on the second web.

The separation and lamination steps can occur sequentially or simultaneously. In a preferred embodiment a heated roller will press the lamina against a defined substrate as the excess from the first web is removed to a take-up spool.

The lamina materials comprise one or more of the materials known for this purpose. Useful materials include, but are not limited to, polymers such as polyester, polyether, polyurethanes, polybutane, and copolymers of one or more thereof.

The lamina materials will preferably have a suitable adhesive on the surface of the lamina that will be exposed to the substrate. The adhesive is applied to the whole surface of the web or, preferably, only to the area of each patch. The adhesive is non-tacky or only slightly tacky when the web is on the spool but becomes tacky or sticky under pressure and/or heat to bond the patch to the substrate.

The substrate is preferably a card, such as an identification card, a credit card, or other CR80 size card. However, other substrates could be laminated using the teachings of the present invention.

### BRIEF DESCRIPTION OF THE DRAWINGS

For a better understanding of the invention, its advantages and objects obtained by its use, reference should be made to the drawings which form a further part hereof, and to the accompanying description, in which there is described a preferred embodiment of the invention.

FIG. 1 is a top view of a portion of a supply web comprising a lamina according to the present invention;

FIG. 2 is a schematic view of a lamination system according to the invention; and

FIG. 3 is a schematic detail view of the system shown in FIG. 2.

### DETAILED DESCRIPTION OF THE INVENTION

Referring now to the drawings, in which like reference characters designate identical or corresponding parts throughout the several views, a system for laminating cards or documents of the present invention is depicted.

The invention relates to a wasteless lamination mechanism for laminating a substrate with a protective plastic topcoat or lamina. Substrates with which the invention is preferably used includes plastic cards, such as financial (e.g. debit and credit) cards, driver's licenses, and identification cards. However, the invention can also be used with other identification and/or financial document substrates, including passports, and other substrates that benefit from having a protective topcoat laminated thereto. For sake of convenience, the word “substrate” as used herein and in the claims is intended to refer to and encompass each of these different types of documents. When a lamina is applied to a specific type of substrate, the name of the substrate will be recited.

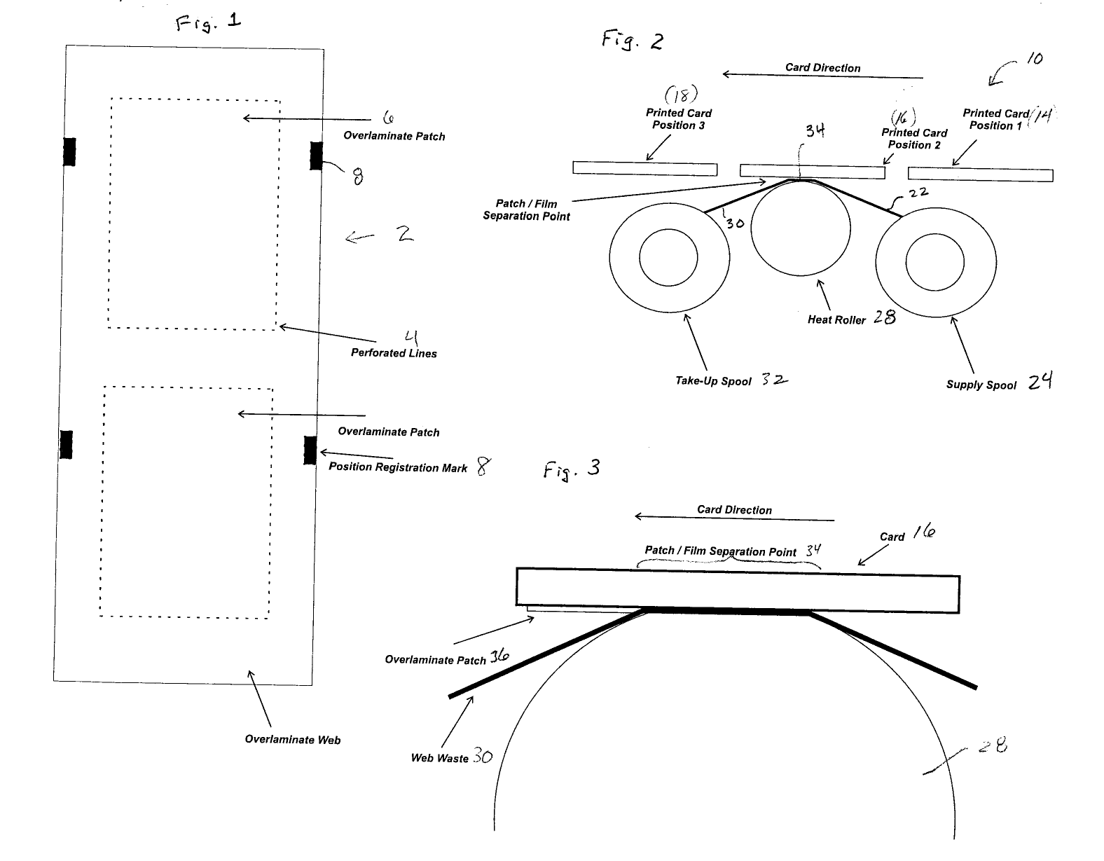

According to FIG. 1, a single film layer or web has a section 2 of lamina material having score lines or weakened lines 4 that define overlaminate or laminate patches 6. The lamina material is preferably a polyester film with a thermal transfer adhesive on one surface. Preferably, the lamina material has a width of about 66 mm and the length is variable depending on the size of the spool. Material sold under the mark TRANSGUARD Trnsilwrap Company of Franklin, Ill. is satisfactory for the purposes of the present invention. Holographic laminate material can also be used such as the type made by Crown Roll Leaf and Holipak Industries of New Jersey. Also, for reverse image printing, a vinyl chloride-vinyl acetate coated film can be used. The corners can be cut with laser cuts to make them smooth and the transverse lines with reduced strength can be made so that the desired tension load will cause the individual sections to separate.

Overlaminate patches 6 are preferably rectangular in shape and substantially the same shape and size as a credit card, however the overlaminate patch 6 may come in other shapes sized to fit a particular substrate. Overlaminate patch 6 may have rounded corners that are formed to fit card corners the transverse weakened lines 4 that delineate the individual laminate sections can be made by laser cutting. Weakened lines 4 can be made by reducing the material thickness when the web is made, by perforating the web material, or by die cutting slits across the web material. The smooth edges can be obtained by all three forms, but die cutting or laser cutting, which both permit cutting the rounded corners at the same time as the transverse weakened lines 4 are exemplary. Weakened lines 4 facilitate perforation of overlaminate patches 6 from section 2. Each overlaminate patch 6 has a length of about 83 mm, a width of about 51 mm and a thickness from about 1 to about 1.5 mm thick.

Weakened lines 4 preferably comprise perforations that are pre-formed in the web. The perforations border each patch 6 and facilitate separation of patch 6 from section 2. Section 2 includes registration marks 8 positioned on the edges of section 2 facilitate coordination during lamination. Registration marks 8 are effective to latch on to sections of the take-up spool 32 and the heat roller 28, which help moved the web 22 forward. Weakened lines 4 are designed to have a break strength that will permit snapping the sections from the web easily.

FIG. 2 represents a schematic of a lamination system 10 where a web 12 comprises a card to be laminated, such as a credit card or other CR80 size card, shown prior to lamination 14, shown during lamination 16, and shown after lamination 18. A web 22 of previously perforated lamina material is delivered from a supply spool 24 to a heat roller 28 for separation along the weakened lines 4. Supply spool 24 and take up spool 32 both are cylindrical in shape and have a diameter of about 110 mm. A typical laminate roll attached to a supply spool is bout 66 mm wide and about 28.6 meters in length when fully deployed. Position registration marks 8 are positioned along heat roller 28 to ensure that supply spool 24 is in the correct position.

Heat, in the range of about 135 to 185° C., and pressure are applied by heat roller 28 at separation station or point 34 to cause an overlaminate or laminate patch 36 to separate from web 22 and attach to card 16 is indexed to an individual substrate such as a document or card 16, as shown in FIG. 3, and applied as a laminate edge-to-edge, end-to-end, and around the corner configurations of the substrates. All, or substantially all, of card 16 is covered by overlaminate or laminate patch 6. The remaining lamina material 30 not applied to the substrate is taken up by take-up spool 32.

Lamination system 10 may also include an optical through sensor to determine when a patch is in the correct position. The optical sensor's signal is broken when the printed mark of the carrier crosses in front of it, thus identifying the patches' position.

Preferably web 22 comprises pre-perforation patches 36. Optionally, system 10 may be provided with a perforation mechanism between spool 24 and separation point 34 that forms perforated lines 4 at the appropriate locations on web 12 after supply spool 24 is loaded into system 10.

The system of the invention preferably comprises conventional features that are known to those skilled in the art and are not described in great detail but are nonetheless considered part of the invention. For example, there are different ways in which an overlaminate or laminate patch 6 could be separated from a web section 2, including mechanical devices.

Sensors and other means can be used to sense registration marks or other indicia to allow the web sections and cards to align properly so that the overlaminate patches are properly positioned on the cards. Optical through sensors are used to determine when a patch is in the correct position. the optical sensor's signal is broken when the printed mark of the carrier crosses in front of it.

The laminate material for forming the laminate sections does not have to be clear, but can be opaque for some uses. The section can be formed to a precise size and laminated on top of each other to form a multi-lay card, such as the 3M Secure® Card. The section can be separated and fed for lamination of plurality of layers to form such a card. Each laminate section is applied to an underlying layer.

Unless defined otherwise, all technical and scientific terms used herein have the same meaning as commonly understood by one of ordinary skill in the art to which this invention pertains. Although any methods and materials similar or equivalent to those described herein can also be used in the practice or testing of the present invention, the preferred methods and materials are now described.

The invention has been described with reference to an embodiment that illustrates the principles of the invention but which is not meant to limit the scope of the invention. Modifications and alterations may occur to others upon reading and understanding the preceding detailed description. It is intended that the scope of the invention be construed as including all modifications and alterations that may occur to others upon reading and understanding the preceding detailed description insofar as they come within the scope of the following claims or equivalents thereof. Various changes may be made without departing from the spirit and scope of the invention.

What is claimed is:

1. A lamination system comprises:
a lamina supply to supply a first web comprising lamina sheets or patches,
a substrate supply to supply a second web having defined substrates to be laminated, and
a separation station where lamina sheets or patches from the first web are laminated to the defined substrates.

2. The lamination system of claim 1, wherein the first web comprises overlaminate or laminate patches that are defined by weakened lines.

3. The lamination system of claim 2, wherein the weakened lines are formed by scoring or perforations.

4. The lamination system of claim 1, wherein the sheets or patches have a coating of adhesive.

5. The lamination system of claim 1, wherein the lamina supply is supplied from a spool.

6. The lamination system of claim 1, wherein at the separation station the laminar sheets or patches are subjected to heat and/or pressure to cause them to bond to substrates.

7. The lamination system of claim 1, wherein after the separation station any remaining first web is collected on a spool.

8. The lamination system of claim 1, wherein the substrates are card-shaped and card-sized.

9. The lamination system of claim 1, wherein each sheet or patch is approximately the same size as the substrates.

10. A method of laminating an object, comprising:
supplying a first web comprising lamina sheets or patches;
supplying a second web having defined substrates to be laminated;
separating the lamina sheets or patches from the first web; and
laminating the lamina sheets or patches to the defined substrates.

11. The method of claim 10, wherein the first web comprises overlaminate or laminate patches that are defined by weakened lines.

12. The method of claim 11, wherein the weakened lines are formed by scoring or perforations.

13. The method of claim 10, wherein the sheets or patches have a coating of adhesive.

14. The method of claim 10, wherein the lamina supply is supplied from a spool.

15. The method of claim 10, wherein at the separation station the laminar sheets or patches are subjected to heat and/or pressure to cause them to bond to substrates.

16. The method of claim 10, wherein after the separation station any remaining first web is collected on a spool.

17. The method of claim 10, wherein the substrates are card-shaped and card-sized.

18. The method of claim 10, wherein each sheet or patch is approximately the same size as the substrates.
